(19) United States
(12) Patent Application Publication
(10) Pub. No.: US 2007/0258744 A1
(43) Pub. Date: Nov. 8, 2007

(54) System and method for adjusting front-to-back printer registration

(76) Inventors: Roman D. Liccini, Los Angeles, CA (US); William Samuel Jacobs, Los Angeles, CA (US)

Correspondence Address: George Likourezos, Esq.;Carter, DeLuca, Farrel & Schmidt, LLP, Suite 225, 445 Broad Hollow Rd., Melville, NY, 11747, US

(21) Appl. No.: 11/416,062

(22) Filed: May 2, 2006

(51) Int. Cl. B41J 5/30

(52) U.S. Cl. 400/62

(57) ABSTRACT

A printing system and method is provided for processing a print job request. The method includes receiving at least one registration variable related to at least one characteristic selected from a characteristic of a target substrate to be marked in accordance with the print job request, and a characteristic of the print job request other than user-entered registration parameters, and determining at least one registration parameter based on the at least one registration variable. The at least one registration parameter is provided to a rasterizer module of the target printing device for defining an offset in at least one direction of a rasterized image that is generated by the rasterizer module, wherein the rasterized image corresponds to image data of the print job request.

### BACKGROUND

The present disclosure relates generally to printer registration. In particular, the present disclosure relates to adjusting front-to-back printer registration.

A printing device for marking a substrate registers the markings on the substrate for proper alignment of the markings on the substrate. When two sided printing is performed for marking opposite sides of the substrate, the printer registers the markings on the opposite sides of the substrate for the markings on the opposite sides to be aligned with one another. Misalignment of markings on opposite sides of the substrate may be easily discriminated, such as by holding the substrate up to a light. Customers of printer device manufacturers have high expectations for front-to-back registration and a low tolerance for any misalignment, e.g., no tolerance for misalignment of 0.5 mm or more. When the front-to-back registration is unacceptable, the customer may request service by a technician.

Printing devices typically have a single set of registration parameters that are used for all submitted print jobs. The registration parameters may be set by a technician to provide acceptable registration under certain conditions. However, when one or more conditions are changed, the front-to-back registration may be affected and misalignment may occur. Conditions which have been noticed to affect front-to-back registration include substrate characteristics (e.g., paper stock, finish, thickness, dimensions, weight, composition (e.g., linen or cotton content), etc.) and print job type (e.g., the type of two-sided printing, such as duplex or tumble).

A customer may compensate for a front-to-back registration error by manually tweaking the print job that is submitted to the printing device for proper front-to-back registration on the printing device. However, the modifications to the print job may not be helpful when printing the print job using a different printing device. In general, manual tweaking of registration parameters or a print job is tedious and applicable for a specific combination of printing device, substrate type and print job type.

Prior art printing devices have provided for adjustment of parameter settings of the marking engine of the printing device for compensating for front-to-back registration discrepancies related to substrate media type. However, adjustment of the front-to-back registration is limited to control of components of the marking engine. For this reason, prior art printer controllers must be reconfigured for new print engine technologies used by printer providers.

To overcome the drawbacks in the prior art, it is an aspect of the present disclosure to provide a system and method for adjusting front-to-back registration, where the adjusting is independent of the components of the marking engine.

### SUMMARY

The present disclosure is directed to a printing system including a printer device having a print controller and a marking engine. The print controller includes a processor assembly having at least one processor in communication with the marking engine, wherein the at least one processor executes software for receiving a print job request including image data and at least one registration variable related to at least one characteristic selected from a characteristic of a target substrate and a characteristic of the print job request other than user-entered registration parameters. The at least one processor includes a registration module for processing the at least one registration variable and determining at least one corresponding registration parameter, and a rasterizer module for processing the image data and generating a corresponding rasterized image, wherein the rasterized image is offset in at least one direction in accordance with the at least one registration parameter. The rasterized image is provided to the marking engine for marking the target substrate in accordance with the rasterized image.

The present disclosure is also directed to a processor assembly for processing a print job request. The processor assembly includes a registration module for receiving at least one registration variable related to at least one characteristic selected from a characteristic of a target substrate to be marked in accordance with the print job request, and a characteristic of the print job request other than user-entered registration parameters, and for determining at least one registration parameter based on the at least one registration variable. The at least one registration parameter is provided to a rasterizer module of the target printing device for defining an offset in at least one direction of a rasterized image that is generated by the rasterizer module, wherein the rasterized image corresponds to image data of the print job request.

The present disclosure is also directed to a method for processing a print job request. The method includes receiving at least one registration variable related to at least one characteristic selected from a characteristic of a target substrate to be marked in accordance with the print job request, and a characteristic of the print job request other than user-entered registration parameters, and determining at least one registration parameter based on the at least one registration variable. The at least one registration parameter is provided to a rasterizer module of the target printing device for defining an offset in at least one direction of a rasterized image that is generated by the rasterizer module, wherein the rasterized image corresponds to image data of the print job request.

Other features of the presently disclosed network printing system will become apparent from the following detailed description, taken in conjunction with the accompanying drawings, which illustrate, by way of example, the presently disclosed network printing system.

### BRIEF DESCRIPTION OF THE DRAWINGS

Various embodiments of the present disclosure will be described below with reference to the figures, wherein:

FIG. 1 is a block diagram of an exemplary printing system in accordance with the present disclosure;

FIG. 2 is a block diagram of an exemplary registration module and storage device of the printing system shown in FIG. 1;

FIG. 3 is an exemplary dialog box displayed via a graphical user interface for facilitating interaction between a user and the registration module shown in FIG. 2;

FIG. 4 is a block diagram of an exemplary printing system in accordance with another embodiment of the present disclosure; and

FIG. 5 is an exemplary dialog box displayed via a graphical user interface for facilitating interaction between the user and a registration module of an output manager or a remote or local computer or terminal shown in FIG. 4.

### DETAILED DESCRIPTION

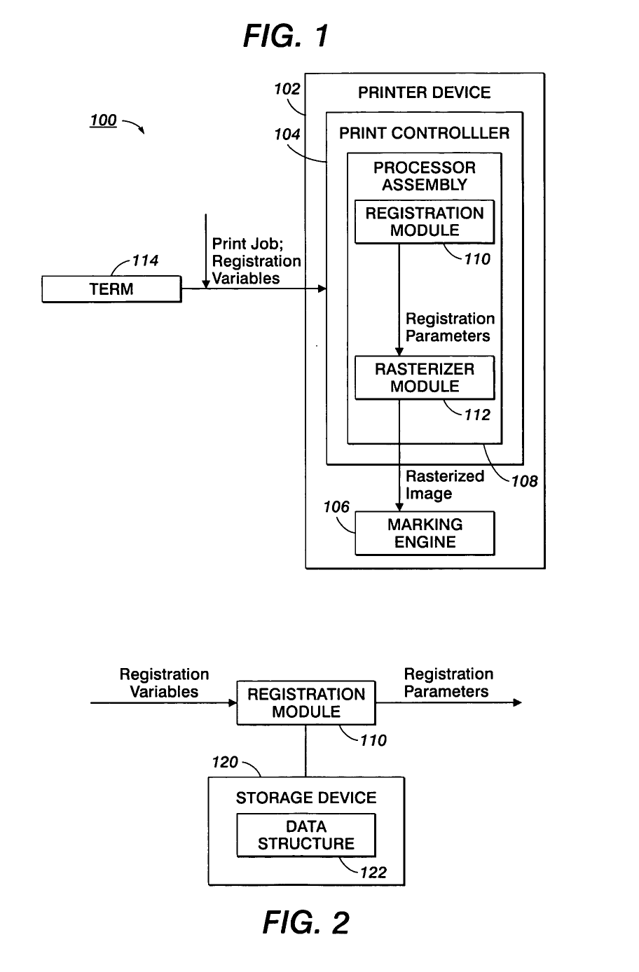

Referring now to the drawing figures, in which like references numerals identify identical or corresponding elements, the network printing system and method in accordance with the present disclosure will now be described in detail. With initial reference to FIG. 1, an exemplary printing system in accordance with the present disclosure is illustrated and is designated generally as printing system 100. Printing system 100 includes a printer device 102 having a print controller 104 receiving a print job request including image data (e.g., representing a document) and print job data, and a marking engine 106 for marking a substrate with an image that corresponds to the image data in accordance with the print job data. The print controller 102 includes a processor assembly 108 having at least one processor. The print controller 102 can be an application specific integrated circuit (ASIC).

The processor assembly 108 includes a registration module 110 and a rasterizer module 112. The registration module 110 provides for customized registration including front-to-back registration of print jobs specifying tumble and duplex printing, but is not limited thereto, and may include registration of print jobs specifying simplex printing. The customized registration is performed by generating registration parameters based on at least one characteristic of the target substrate and/or the print job data, where the at least one characteristic is referred to as registration variables. The rasterizer module 112 rasterizes the image data for generating rasterized image data, where the rasterized image data is offset in at least one direction in accordance with the registration parameters. The marking engine 106 receives the rasterized image data and marks the target substrate using the rasterized image data.

Each software module, including the registration module 110 and the rasterizer module 112 includes a series of programmable instructions capable of being executed by the processor assembly 108. The series of programmable instructions can be stored on a computer-readable medium, such as RAM, a hard drive, CD, smart card, 3.5″ diskette, etc., or transmitted via propagated signals for being executed by the processor assembly 104 for performing the functions disclosed herein and to achieve a technical effect in accordance with the disclosure. The functions of the respective software modules may be combined into one module or distributed among a different combination of modules.

The word “printer device” as used herein encompasses any apparatus or system, such as a digital copier, xerographic printing system, ink jet printing system, reprographic printing system, bookmaking machine, facsimile machine, multifunction machine, textile marking machine, etc., which performs a marking output function for any purpose. The modality for marking may include, for example, applying toner, ink, dye, etc., to the substrate or embossing, peening, etching, etc. the substrate. The substrate may be a material such as paper, cardboard, a transparency, a paper derivative, metal, plastic, glass, wood, cloth, etc.

The print job data and the registration variables may be received from a remote or local computer or terminal 114 requesting that a print job be executed, another computing device (not shown in FIG. 1), a scanner device of the printer device 102 and/or a via a control panel of the printer device 102. The scanner device may include a light source generating light, and an array of at least two sensors for sensing incident light reflected from a source substrate. A plurality of remote or local computers or terminals 114 may be provided that submit print job data to the print controller 104. The remote or local computer(s) or terminal(s) 114 and the printer device 102 are in operative communication via wired or wireless communication. The communication may be via one or more networks, but is not limited thereto.

The image data includes the data to be printed which is provided in a printer ready language, often referred to as a page description language, such as PostScript™, PDF™, or PCL™. The print job data describes specifications for the print job, such as plex (e.g., simplex, duplex or tumble printing), page orientation, selection of a specific printer device, substrate dimensions, etc., which pages of the document to print, finishing instructions (e.g., staple, binding, folding, etc.), scaling instructions, etc.

With reference to FIGS. 1 and 2, the at least one processor of the processor assembly 108 is in operative communication with at least one storage device 120 storing a data structure (DS) 122, such as a database or look-up-table (LUT) that stores information related to a plurality of registration variable values. The storage device 120 may be integrated with the print controller 104 and/or the printer device 102, or the storage device 120 may be external from the printer device 102. Communication between the processor assembly 122 and the storage assembly 120 may be wired or wireless, including via a network, such as a LAN, WAN or the Internet. For example, the storage device 120 may be accessible to the processor assembly 122 via a website. Access to information stored in the data structure 122 may be provided in accordance with subscription to a service and/or for a fee.

Where the data structure 122 is provided with the printer device 102, updates to the data structure 122 may be provided to the data structure 122 from another processing device, such as from an Internet website via a download initiated by the printer device 102 or the website. Additionally, when information is available via the data structure 122 of the printer device 102, the information may be automatically downloaded to the processor assembly 108 from another source, such as from the Internet website.

The registration module 110 and the rasterizer module 112 operate on the print job request and together produce a registered and rasterized image that is output to the marking engine 106. The marking engine 106 physically marks the substrate in accordance with the registered and rasterized image. The print controller 104 may additionally generate control signals and provide the control signals to the marking engine 106 for controlling the marking process.

When a user submits a print job request from the remote or local computer or terminal 114 or from the printer device 102 itself (e.g., when copying a document), the user typically enters print job instructions, such as target paper size and orientation, scaling, finishing instructions, etc., which is included in the print job data. The registration module 110 retrieves and/or receives the registration variables from the print job data and/or other sources. The registration variables include, for example, one or more target substrate characteristics, (e.g., paper stock, substrate dimensions, substrate composition (e.g., linen or cotton content), substrate weight, substrate finish, substrate grain, substrate manufacturer and/or substrate type information, etc.). Finish information may indicate if the substrate is coated, uncoated, on which side(s) it is coated, the type of coating, (e.g., dull, gloss, matte, etc.), etc.

Grain information may indicate the grain direction, which refers to the direction in which the fibers of the substrate are aligned or became aligned during the papermaking process, e.g., running parallel or perpendicular to the length of the substrate. The grain affects the folding ability and strength of the substrate, and the degree to which the substrate expands against the grain when exposed to chemicals, such as a dampening solution or moisture in the air. Manufacturer information may indicate the manufacturer of the substrate. Type information may indicate the translucency, shape or form of the substrate, e.g., the way in which the substrate is cut, e.g., precut tab, full cut tab, envelope, transparency, etc. The substrate type may affect how well the substrate moves through the printer device, as well as registration.

The registration variables may further include one or more characteristics related to the print job request, such as plex, scaling instructions, finishing instructions (e.g., binding, stapling, folding, etc.), etc. Information about the substrate, such as substrate composition, weight, finish, grain, manufacturer, type, and/or dimensions, may be input by a user or a processing device (as described above), and/or sensed by sensors provided with the printer device 102.

The target substrate is supplied by a target source. In printer device 102, the target source typically includes at least one paper drawer, each paper drawer storing and providing a paper of a particular type (e.g., dimension, weight, etc.) and oriented in a particular orientation (e.g., landscape or portrait). The paper drawer from which the target substrate is supplied is selected in accordance with specifications provided in the print job data, e.g., dimensions and orientation of the target substrate.

In addition to dimension and orientation information, additional information about the paper stored in the paper drawer may be stored by the printer device 102, such as manufacturer, product number, weight, composition (e.g., linen or cotton content), etc. The additional information may be entered by a user when loading the paper into the paper drawer, or may be sensed by a sensor in the paper drawer. The paper drawer may be provided, for example, with an optical code sensor, and the bottom paper or packaging for the paper may be provided with an optical code (e.g., barcode) in which the additional information is encoded. When loading the paper drawer, the optical code sensor may sense the optical code and store the encoded information about the type of paper stored in the particular paper drawer being loaded.

Sensing may be performed once the substrate has been positioned by the marking engine for performance of the marking operation. Another type of sensing is when a document to be copied is sensed while positioned on the scanner plate or platen glass. Substrate characteristics that may be sensed, include, for example, paper weight, paper composition (e.g., linen or cotton content), and paper dimensions. Information related to the sensor output is provided to the registration module 110, and may be included with the print job data, even if not received together with other data of the print job data. The registration variables may be obtained from the information related to the sensor output.

The registration module 110 may alternatively (or in addition to the information provided upon submission of the print job request) request substrate information and/or other print job information (e.g., plex, finishing instructions, etc.), such as by prompting a user of the remote or local computer or terminal 114 or of the printer device 102, e.g., via a display of the printer device 102 console by using a graphical user interface (GUI). When substrate or other print job information is not entered or available, the registration module 110 may assume default values for at least a portion of the registration variables.

The registration module 110 accesses the data structure 122 using the registration variable(s) as an index key or a combination of index keys, and retrieves the corresponding registration parameters from the data structure 122. Combination of more than one index key may be performed in a variety of ways that are known in the art. For example, the data structure 122 may have one index for many types of paper, each type of paper having a variety of characteristics (dimensions, composition (e.g., linen or cotton content), weight, etc.). Each paper type may be identified by an identification code, such as manufacturer and product code, and/or by one or more characteristics.

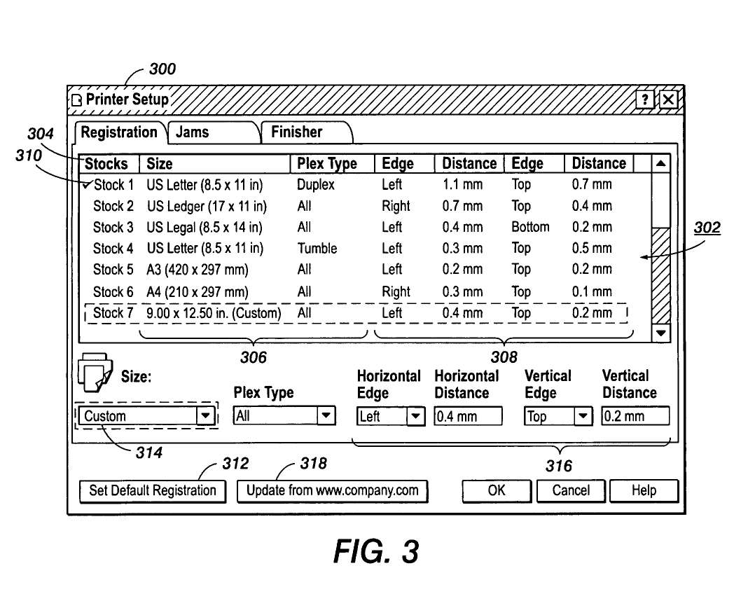

FIG. 3 shows a dialog box 300 displayed via a GUI which facilitates interactive communication between the user and the registration module 110 for accessing content of the data structure 122. As displayed in dialog box 300, print job entries 302 are indexed in accordance with stock number. The stock number indexes are listed in a column designated by reference numerals 304. Each stock number represents a set of paper dimensions and a plex type. A description 306 of the paper size and plex type is provided for each stock number. Each print job entry is further provided with a set of registration parameters 308, which are adjustment factors providing horizontal or vertical offsets from the specified edge. The measurement units used in the dialog box 300 may be automatically selectable by another processor or manually selectable by a user, such as via a graphical user interface (GUI) provided at the console of the printer device.

One of the print job entries is selected to be a default entry (designated by the check mark 310), which is used under default conditions, such as when the paper dimensions or plex type are not known or are not found in the data structure 122. Default selection is performed using button 312. An administrator may enter one or more customized entries 314 and a set of customized registration parameters 316 to be associated with the customized entry 314. The administrator may download updated registration parameters using button 320. Activation of button 320 causes a registration update website to be accessed from which the updated registration parameters may be downloaded.

The registration parameters for each entry may further include a first set of adjustment factors for a first side of a page, and a second set of adjustment factors for a second side of a page. The first and second sets of adjustment factors may be different, such as when the pages are duplex printed and bound. The first set of adjustment factors may shift the image to the right to provide space in the left margin for the binding, and the second set of adjustment factors may shift the image to the left to provide space in the right margin for the binding. Furthermore, under certain circumstances, the size of the substrate may be different when printing on the first and second sides, such as due to shrinkage caused by the fusing process during printing of the first side. The first and second sets of adjustment factors may be different to accommodate for the size differential of the substrate when printing the first and second sides.

The registration module 110 may cause the dialog box 300 to be displayed to the user at the user's remote or local computer or terminal 114 or the printer device's console for allowing the user to manually select the registration parameters 308 or 316. Alternatively, the registration module 110 may automatically retrieve the registration variables and select the registration parameters using the data structure 122 without any action by the user other than submission of the print job request.

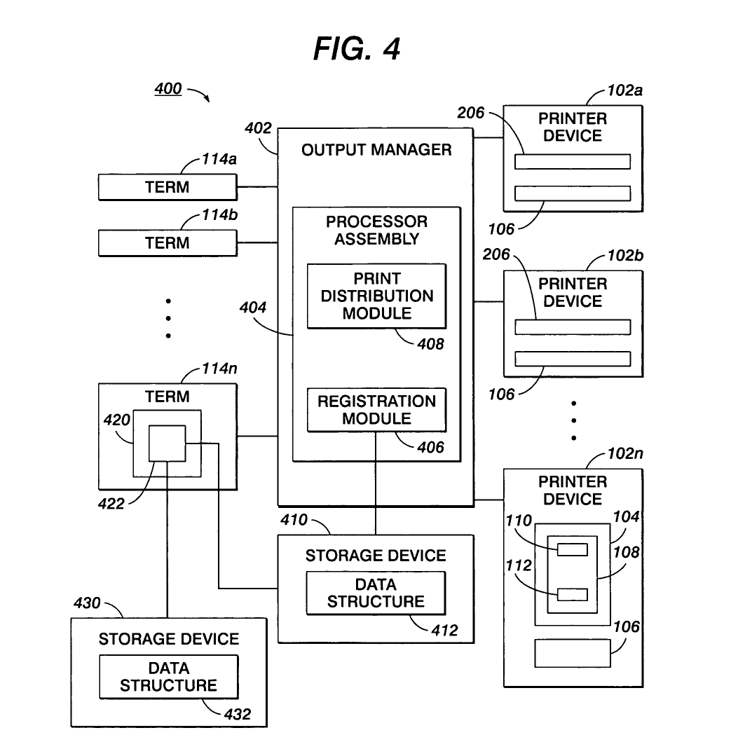

With reference to FIG. 4, an exemplary printing system 400 is shown having a plurality of computers or terminals 114a-114n submitting print job requests. The plurality of terminals 114a-114n are in operative communication with an output manager 402, which directs the respective print job requests to a selected printer device 102 of a plurality of printer devices 102a-102n. The printer devices 102a-102n each have a printer controller 206 or 104 and a marking engine 106. The printer devices 102a and 102b each have a prior art printer controller 206 which includes at least one processor and a rasterizer module 112. The prior art printer controllers 206 are not provided with a registration module 110. The printer device 102n is shown having a printer controller 104, including a processor assembly 108, registration module 110 and rasterizer module 112, as shown in FIG. 1. The plurality of printer devices 102a-102n may include only printer devices 102 having a prior art printer controller 204, only printer devices 102 having a printer controller 104 provided with a registration module 110, or a combination thereof.

The output manager 402 includes a processor assembly 404 having at least one processor. The processor assembly 404 is provided with a registration module 406 and a print distribution module 408, each including a series of programmable instructions capable of being executed by the processor assembly 404 for performing the functions disclosed herein and to achieve a technical effect in accordance with the disclosure. The functions of the respective software modules may be combined into one module or distributed among a different combination of modules.

Print job requests submitted by remote or local computers or terminals 114a-114n are received by the output manager 402. The print distribution module 408 selects a printer device 102 from the plurality of printer devices 102a-102n, and the output manager 402 transmits the print job request to the selected printer device 102 for printing thereof. The print distribution module 408 may be a prior art module for receiving print job requests and distributing the print job requests to the plurality of printer devices 102a-102n, such as based on availability, a printer profile associated with each printer device 102, printer device 102 capability, etc.

Once the printer device 102 is selected, and before the output manager 402 transmits the print job request to the selected printer device 102, the registration module 406 determines registration parameters to be transmitted to the selected printer device 102. The registration parameters may be transmitted at the same time as and/or together with the print job request, but the disclosure is not limited thereto. The registration module 406 receives the registration variables, which includes an indication or identification of the selected printer device 102, such as a printer identification code identifying the selected printer. Functioning in a substantially similar fashion to registration module 110, registration module 406 processes the registration variables for determining the registration parameters to be used for printing using the selected printer device 102. A difference between registration module 406 and registration module 110 is that registration module 110 determines registration parameters for a print job request directed to one printer device 102, and registration module 406 determines registration parameters for print job requests that are directed to a selected printer device 102 of a plurality of printer devices 102a-102n, where different registration parameters may be used for the different printer devices 102a-102n.

The at least one processor of the processor assembly 404 is in operative communication with at least one storage device 410 storing a data structure 412, such as a database or look-up-table (LUT) that stores information related to a plurality of registration variable values. The storage device 410 may be integrated with the output manager 402, or the storage device 410 may be external from the output manager 402. Communication between the processor assembly 404 and the storage device 410 may be wired or wireless, including via a network, such as a LAN, WAN or the Internet. For example, the storage device 410 may be accessible to the processor assembly 404 via a website. Access to information stored in the data structure 412 may be provided in accordance with subscription to a service and/or for a fee.

Registration module 406 accesses data structure 412 to determine the registration parameters based on the registration variables and the selected printer device 102. Data structure 412 stores a plurality of entries that are indexed in accordance with registration variables, such as a printer device, e.g., that is identified by a printer device identification code, paper type and/or plex.

The registration module 406 accesses the data structure 412 using the registration variable(s) as an index key or a combination of index keys, and retrieves the corresponding registration parameters from the data structure 412. Combination of more than one index key may be performed in a variety of ways that are known in the art. For example, the data structure 412 may have a first index for printer device identification codes which identify a plurality of printer devices 102, another index for type of paper, each type of paper having a variety of characteristics (dimensions, composition (e.g., linen or cotton content), weight, etc.). Each paper type may be identified by an identification code, such as manufacturer and product codes, and/or by one or more characteristics.

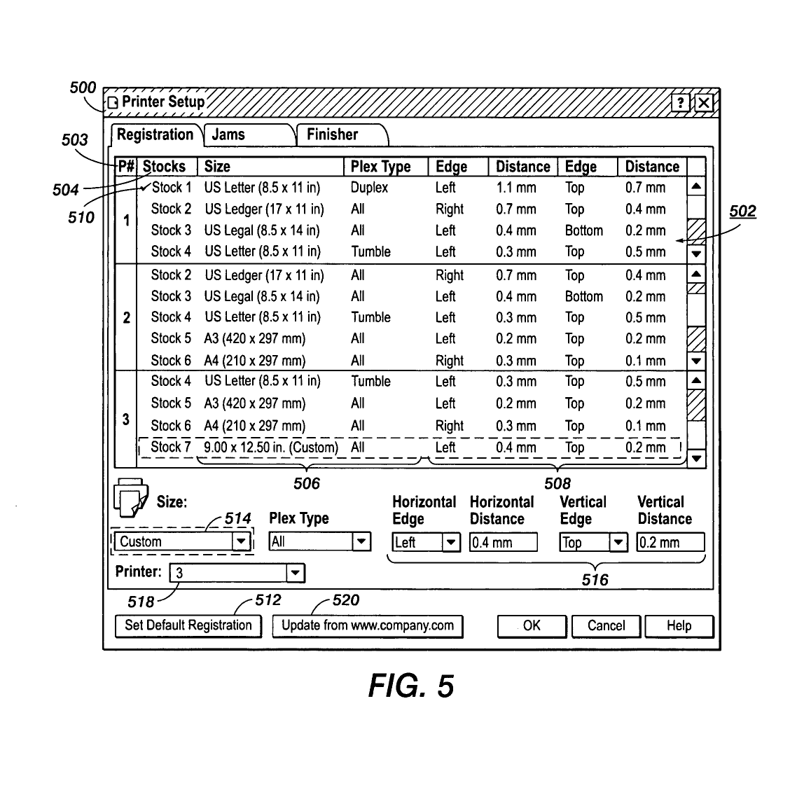

FIG. 5 shows a dialog box displayed via a GUI displaying content of the data structure 412, and allowing the user to interactively communicate with the registration module 406. As displayed, print job entries 502 are indexed in accordance with a printer device identification code (P#) and sub-indexed in accordance with stock number. The printer device identification code indexes are designated by reference numeral 503, and the stock number indexes are listed in a column designated by reference numeral 504. Each stock number represents a set of paper dimensions and a plex type. A description 506 of the paper size and plex type is provided for each stock number. Each print job entry is further provided with a set of registration parameters 508, which are adjustment factors providing horizontal or vertical offsets from the specified edge. The registration parameters for each entry may further include a first set of adjustment factors for a first side of a page, and a second set of adjustment factors for a second side of a page. The first and second sets of adjustment factors may be different. The measurement units displayed in the dialog box 500 may be automatically selectable by another processor or manually selectable by a user, such as via a graphical user interface (GUI) provided at a console of the output manager 402.

One of the print job entries is selected to be a default entry (designated by the check mark 510), which is used under default conditions, such as when the paper dimensions or plex type are not known or are not found in the data structure 412. Default selection is performed using button 512. An administrator may enter one or more customized entries 514 and a set of customized registration parameters 516 to be associated with the customized entry 514. The administrator may associate the customized entry 514 with a specific printer, or be applied to all printers using button 518. The administrator may download updated registration parameters using button 520. Activation of button 520 causes a registration update website to be accessed from which the updated registration parameters may be downloaded.

Dialog box 500, provided via a GUI, displays content of the data structure 412. A user may use the dialog box 500 to interactively communicate with the registration module 406, such as for accessing the content of data structure 412, specifying registration variables, entering customized data, selecting registration parameters, initiating a download of data to the data structure 412, etc. The dialog box 500 may be displayed, for example, to a user or administrator configuring one or more printer drivers on a remote or local computer or terminal. These settings will be used during submission of print job requests at the user's remote or local computer or terminal 114, to an administrator of the output manager 402 at the console of the output manager 402, or to an administrator at the console of the selected printer device for allowing the user to manually select the registration parameters 508 or 516. Alternatively, the registration module 406 automatically retrieves the registration variables and selects the registration parameters to be used for the selected printer device 102 and submitted print job request using the data structure 412 without any action by the user other than submission of the print job request.

Printer devices 102a and 102b are not provided with a registration module. When printer device 102a or 102b is selected, registration adjustment is performed by the registration module 406 of the output manager 402. Printer device 102n is equipped with a registration module 110. When printer device 102n is selected, registration adjustment may be performed by either the registration module 406 of the output manager 402, or the registration module 110 of printer device 102n. The output manager 402 may be aware of the capabilities of the selected printer device, and therefore be aware that the selected printer device 102 includes a registration module 110. In this case, the output manager 402 may not perform any registration adjustments. Alternatively, the output manager 402 may still perform registration adjustments. The registration module 110 of the selected printer device 102 may handle the registration parameters provided by the output manager 402 in several ways, in accordance with design choice. The registration module 110 may override incoming registration parameters with registration parameters that it has determined, allow the incoming registration parameters to override registration parameters that it has determined, or may forego determining registration parameters and use the incoming registration parameters.

The output manager 402 provides for performing registration adjustments at the queue level, where individual print job requests on a queue being handled by the output manager 402 are handled individually and may have different registration parameters, respectively. The output manager 402 determines one or more characteristics of the substrate based on the printer device 102 selected and the substrate source, e.g., paper drawer, to be used for the selected paper. Accordingly, the output manager 402 retrieves the registration variables, including the substrate characteristics, selected printer device 102 information, and/or plex type (which is specified in the print job data, explicitly or by default), accesses the data structure 412 and automatically retrieves registration parameters. The registration parameters are provided to the selected printer device 102. The rasterizer module 112 generates the rasterized image that corresponds to the print job request received by the processor assembly 108, including offsetting the rasterized image that corresponds to the image data of the print job request in accordance with the registration parameters.

With reference to FIG. 4, the remote or local computer or terminal 114n includes at least one processor 420 which may executes a registration module 422, e.g., provided as software. Registration module 422 includes a series: of programmable instructions capable of being executed by the at least one processor 420 for performing the functions disclosed herein and to achieve a technical effect in accordance with the disclosure. The functions of the software module may be combined with one or more other software modules. Registration module 422 functions in a substantially similar fashion to registration module 110, including processing the registration variables for determining the registration parameters to be used for printing using the printer device 102 (or selected printer device). In one exemplary printing system 100, computer or terminal 114n may print to only one printer device 102. Registration module 422 may determine registration parameters for a print job request directed to the one printer device 102 in accordance with the registration variables describing one or more characteristics of the target substrate and/or the plex. In another exemplary printing system 100, computer or terminal 114n may print to a printer device 102 selected from a plurality of printer devices 102. Registration module 406 determines registration parameters for a print job request that is directed to a selected printer device 102 of the plurality of printer devices 102a-102n, where different registration parameters may be used for the different printer devices 102a-102n. The registration parameters are selected in accordance with the selected printer device 102 and the registration variables describing one or more characteristics of the target substrate and/or the plex of the print job request.

The processor 420 accesses the at least one storage device 410 for accessing data structure 412, or at least one storage device 430 for accessing data structure 432. Data structure 432, e.g., a database or LUT, stores registration parameters related to a plurality of registration variable values. The storage device 430 may be local to the computer or terminal 114n, e.g., integrated with the computer or terminal 114n or provided as a removable storage device, or the storage device 430 may be external from the computer or terminal 114n. Communication between the computer or terminal 114n and the storage device 430 or storage device 410 may be wired or wireless, including via a network, such as a LAN, WAN or the Internet. For example, the storage device 430 may be accessible to the computer or terminal 114n via a website. Access to information stored in the data structure 432 may be provided in accordance with subscription to a service and/or for a fee.

Registration module 420 accesses data structure 412 or 432 to determine the registration parameters based on the registration variables and the selected printer device 102. Data structure 432 stores a plurality of entries that are indexed in accordance with a printer device 102 (e.g., that is identified by a printer device identification code), one or more substrate characteristics and/or plex. The data structure 432 may include a LUT. Via a GUI the user may communicate interactively with the registration module 420 and access content of the LUT, such as via a dialog box similar to the dialog box 300 shown in FIG. 3 or dialog box 500 shown in FIG. 5.

The registration module 420 accesses the data structure 432 using the registration variable(s) and/or selected printer device identification code as an index key or a combination of index keys, and retrieves the corresponding registration parameters from the data structure 432. Combination of more than one index key may be performed in a variety of ways that are known in the art. For example, the data structure 432 may have a first index for printer device identification codes which identify a plurality of printer devices, another index for type of paper, each type of paper having a variety of characteristics (e.g., dimensions, composition (e.g., linen or cotton content), weight, etc.). Each paper type may be identified by an identification code, such as manufacturer and product code, and/or by one or more characteristics.

When registration adjustment may be performed by more than one component of the printing system, such as by the computer or terminal 114n, the output manager 402, as shown in FIG. 4, and/or by the printer device (e.g., printer device 102 shown in FIG. 1 or printer device 102n shown in FIG. 4), priority for which component performs registration adjustment, and which component's registration parameters are used is determined in accordance with product design. Accordingly, the registration parameters may be selected by a component of the printing system (e.g., exemplary printing system 100 shown in FIG. 1 or exemplary printing system 400 shown in FIG. 4), where the component is selected from one of the computer or terminal 114, the output manager 402 and the printing device 102 that prints the document of the print job request.

The registration parameters may be selected automatically by the at least one processor of the respective component by accessing a data structure (e.g., data structure 122, 412, or 422). Alternatively, the registration parameters may be selected manually by an operator of the component by allowing the operator to access the data structure (e.g., data structure 122, 412, or 422). In a printing system having registration parameter selection capabilities in accordance with the disclosure for at least two components of the printing system, such as one or more computer or terminals 114, the output manager 402 and/or one or more printing device 102, the storage devices 120, 420, and/or 430 may be at least partially combined., and the data structures 122, 422 and/or 432 may be at least partially combined.

With reference to FIG. 1 and FIG. 4, in cases in which the registration parameters are selected manually by a user viewing displayed contents of data structure 122, 412 or 432, or in which the registration parameters are selected automatically by the registration module 110, 406 or 422, the registration module consults the data structure for determining the registration parameter that corresponds to the registration variables. When creating, modifying or setting up the data structures 122, 412 and 432, the contents of the data structures 122, 412 and 432 may be determined empirically by determining the registration parameters that achieve the best registration results for each entry.

In prior art printing systems, faulty front-to-back registration due to variations in substrate characteristics, print job characteristics and printer characteristics has resulted in calls for servicing of the printer device or modification by the user of the actual document to be printed to compensate for the faulty registration A printing system provided in accordance with the present disclosure advantageously provides for precision front-to-back registration that is customizable in accordance with at least one of variations in substrate, print job data and/or printer characteristic.

In accordance with the present disclosure, a prior art marking engine may be used with printer device 102 of the printing system 100 shown in FIG. 1 or any of the printer devices 102a-102n of the printing system 400 shown in FIG. 4. The marking engine 106 receives the rasterized image that was modified in accordance with the registration parameters and marks the substrate to form an image that corresponds to the adjusted rasterized image using prior art methods and equipment.

Furthermore, since selection of registration parameters in accordance with the present disclosure may be performed by only one component of a printer system, where the component is any one of the computer or terminal 114, the output manager 402 or the printer device 102, the other components of the printer system may be prior art components that are not designed to perform in accordance with the present disclosure.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A printing system, comprising:
a printer device having a print controller and a marking engine;
wherein the print controller includes:
a processor assembly having at least one processor in communication with the marking engine, wherein the at least one processor executes software for receiving a print job request including image data and at least one registration variable related to at least one characteristic selected from a characteristic of a target substrate and a characteristic of the print job request other than user-entered registration parameters, the at least one processor comprising:
a registration module for processing the at least one registration variable and determining at least one corresponding registration parameter; and
a rasterizer module for processing the image data and generating a corresponding rasterized image, wherein the rasterized image is offset in at least one direction in accordance with the at least one registration parameter;
wherein the rasterized image is provided to the marking engine for marking the target substrate in accordance with the rasterized image.

2. The printing system in accordance with claim 1, wherein at least one of the image data and registration variables are received from a processor in operative communication with the printer device.

3. The printing system in accordance with claim 1, wherein the printer device further includes at least one sensor and at least one of the image data and registration variables is at least partially generated by the at least one sensor.

4. The printing system in accordance with claim 1, wherein at least a portion of the device's registration variables is user-entered, supplied by a manufacturer, or downloaded via the internet.

5. The printing system in accordance with claim 1, wherein the characteristic of the target substrate is selected from the group of characteristics consisting of dimensions, weight, finish, grain, manufacturer, type and composition.

6. The printing system in accordance with claim 1, wherein the characteristic of the print job request is selected from the group of characteristics consisting of plex, binding and finishing.

7. The printing system in accordance with claim 1, wherein the characteristic of the target substrate is sensed by a sensor in operative communication with the processor assembly.

8. The printing system in accordance with claim 1:
wherein the processor assembly is in operative communication with a storage device storing a data structure; and
wherein the data structure stores a plurality of entries, each entry including an index including at least one associated registration variable, and a corresponding at least one associated registration parameter; and
wherein the registration module consults the data structure for determining the at least one registration parameter.

9. The printing system in accordance with claim 8:
wherein the processor assembly is in operative communication with a remote processor; and
wherein the processor assembly communicates with the remote processor for updating the data structure with data stored by a storage device associated with the remote processor.

10. A processor assembly for processing a print job request comprising:
a registration module for receiving at least one registration variable related to at least one characteristic selected from a characteristic of a target substrate to be marked in accordance with the print job request, and a characteristic of the print job request other than user-entered registration parameters, and for determining at least one registration parameter based on the at least one registration variable, wherein the at least one registration parameter is provided to a rasterizer module of the target printing device for defining an offset in at least one direction of a rasterized image that is generated by the rasterizer module, wherein the rasterized image corresponds to image data of the print job request.

11. The processor assembly in accordance with claim 10, wherein the characteristic of the target substrate is selected from the group of characteristics consisting of dimensions, weight, finish, grain, manufacturer, type, and composition.

12. The processor assembly in accordance with claim 10, wherein the characteristic of the print job request is selected from the group of characteristics consisting of identification of a target printer device for marking the target substrate, plex, binding and finishing.

13. The processor assembly in accordance with claim 10, wherein the processor assembly resides in one of a target printer device for marking the target substrate, a computer or terminal submitting the print job request, and an output manager in operative communication with a plurality of printer devices for selecting the target printer device.

14. The processor assembly in accordance with claim 10:
wherein the processor assembly is in operative communication with a storage device storing a data structure;
wherein the data structure stores a plurality of entries, each entry including an index including at least one associated registration variable, and a corresponding at least one associated registration parameter; and
wherein the registration module consults the data structure for determining the at least one registration parameter.

15. The processor assembly in accordance with claim 14:
wherein the processor assembly is in operative communication with a remote processor; and
wherein processor assembly communicates with the remote processor for updating the data structure with data stored by a storage device associated with the remote processor.

16. The processor assembly in accordance with claim 14, wherein the processor assembly further generates a graphical user interface (GUI) for displaying at least a portion of contents of the data structure, and a user interactively selects the at least one registration parameter via the GUI.

17. A method for processing a print job request, the method comprising:
receiving at least one registration variable related to at least one characteristic selected from a characteristic of a target substrate to be marked in accordance with the print job request, and a characteristic of the print job request other than user-entered registration parameters; and
determining at least one registration parameter based on the at least one registration variable, wherein in the at least one registration parameter is provided to a rasterizer module of the target printing device for defining an offset in at least one direction of a rasterized image that is generated by the rasterizer module, wherein the rasterized image corresponds to image data of the print job request.

18. The method in accordance with claim 17, wherein the characteristic of the target substrate is selected from the group of characteristics consisting of dimensions, weight, finish, grain, manufacturer, type and composition, and the characteristic of the print job request is selected from the group of characteristics consisting of identification of a target printer for marking the target substrate, plex, binding and finishing.

19. The method in accordance with claim 17, wherein the determining further comprises:
operatively communicating with a storage device storing a data structure; wherein the data structure stores a plurality of entries, each entry including an index including or associated at least one associated variable, and a corresponding registration at least one associated registration parameter; and
consulting the data structure for determining the at least one registration parameter that corresponds to the received at least one registration variable.

20. The method in accordance with claim 19 comprising:
operatively communicating with a remote processor; and
updating the data structure with data stored by a storage device associated with the remote processor.
